(19) United States
(12) Patent Application Publication
(10) Pub. No.: US 2014/0236713 A1
(43) Pub. Date: Aug. 21, 2014

(54) SERVER, SYSTEM FOR MANAGING INFORMATION, AND METHOD FOR OPERATING COMMUNICATION DEVICE

(71) Applicant: TOSHIBA TEC KABUSHIKI KAISHA, Tokyo (JP)

(72) Inventors: Tsuyoshi GOTANDA, Tokyo (JP); Keiichi HASEGAWA, Tokyo (JP); Taro ANDO, Shizuoka (JP)

(73) Assignee: TOSHIBA TEC KABUSHIKI KAISHA, Tokyo (JP)

(21) Appl. No.: 14/185,638

(22) Filed: Feb. 20, 2014

(30) Foreign Application Priority Data
Feb. 21, 2013 (JP) 2013-032537

(51) Int. Cl. G06Q 30/02

(52) U.S. Cl. CPC G06Q 30/0253
USPC 705/14.51

(57) ABSTRACT

A server for an electronic receipt system includes a storing unit configured to store electronic receipt information including an item purchased by a customer, customer information, and promotion information for a predetermined item, a communication unit configured to receive a request for the electronic receipt information from a communication device, and transmit the electronic receipt information to the communication device, and a controller configured to associate the electronic receipt information with the promotion information if the purchased item is the predetermined item, and control the communication unit to transmit the electronic receipt information with the associated promotion information to the communication device in response to the request for the electronic receipt information.

### CROSS-REFERENCE TO RELATED APPLICATION

This application is based upon and claims the benefit of priority from Japanese Patent Application No. 2013-032537, filed Feb. 21, 2013, the entire contents of which are incorporated herein by reference.

### FIELD

Embodiments described herein relate generally to a server, a system for managing information, and a method for operating a communication device.

### BACKGROUND

An electronic receipt system is known in which an electronic receipt is transmitted to an electronic device, such as a mobile terminal device, of a customer who purchased an item at a retailer. As the customer can receive information about the purchase in an electronic form, the customer can electronically manage his or her purchasing behavior. In addition, as a paper receipt is not necessary, the retailer that introduced the electronic receipt system can reduce the consumption of paper and as a result realize cost savings for the paper receipts.

Furthermore, one type of an electronic receipt is transmitted to the customer with an electronic coupon associated with the item purchased by the customer. By attaching such an electronic coupon, the retailer or a manufacturer of the purchased item can advertise the item and promote the sale of the item.

Conventionally, a retailer or a manufacturer of an item conducts a promotional campaign, in which a token for the campaign is associated with the item. A customer who purchases the item collects tokens and the tokens may be turned in, for example, to obtain a reward.

### DESCRIPTION OF THE DRAWINGS

FIG. 1 shows an overall configuration of an electronic receipt system according to an embodiment.

FIG. 2 is a block diagram showing various elements of a mobile terminal.

FIG. 3 is a block diagram showing various elements of a POS terminal.

FIG. 4 is a block diagram showing various elements of an electronic receipt server.

FIG. 5 is a block diagram showing various elements of an electronic receipt management server.

FIG. 6 is a functional block diagram showing various elements of the POS terminal relating to an electronic receipt process.

FIG. 7 is a flowchart showing a flow of the electronic receipt process.

FIG. 8 is a flowchart showing a flow of an information transmission process performed by the electronic receipt server.

FIG. 9 is a functional block diagram showing elements of the electronic receipt server relating to an electronic receipt management process and a product information transmission process.

FIG. 10 is a flowchart showing flows of the electronic receipt management process and the product information transmission process.

FIG. 11 is a functional block diagram showing elements of the mobile terminal relating to an electronic receipt receiving process and an electronic receipt browsing process.

FIG. 12 is a flowchart showing flows of the electronic receipt receiving process and the electronic receipt browsing process.

FIG. 13 is a front view of the mobile terminal in which a display unit displays an example of an electronic receipt.

FIG. 14 is a front view of the mobile terminal displaying screens used for a campaign application process.

### DETAILED DESCRIPTION

In general, according to one embodiment, an electronic receipt system includes a storing unit configured to store electronic receipt information including an item purchased by a customer, customer information, and promotion information for a predetermined item, a communication unit configured to receive a request for the electronic receipt information from a communication device, and transmit the electronic receipt information to the communication device, and a controller configured to associate the electronic receipt information with the promotion information if the purchased item is the predetermined item, and control the communication unit to transmit the electronic receipt information with the associated promotion information to the communication device in response to the request for the electronic receipt information.

An embodiment will be described with reference to the accompanying drawings.

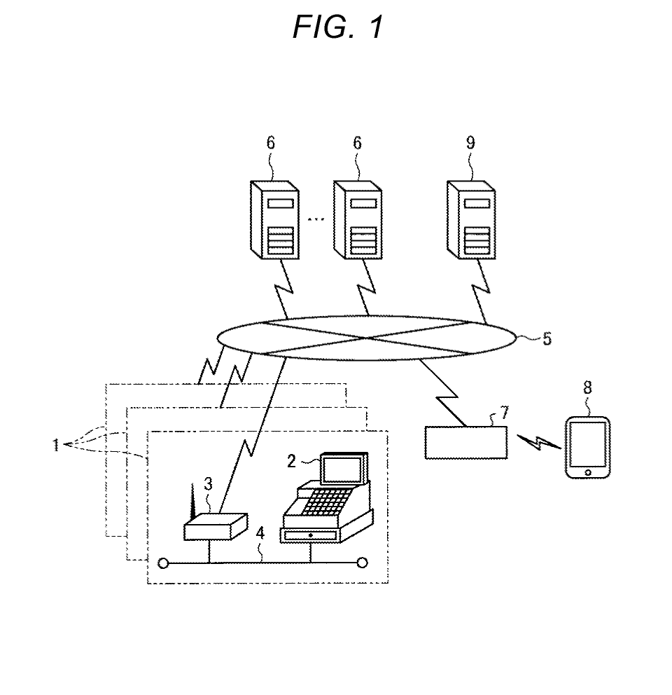

FIG. 1 shows an overall configuration of an electronic receipt system according to the embodiment. As shown in FIG. 1, a Point of Sales (POS) terminal 2, which is a product sales data processing apparatus executing a product sales data process (only a single terminal is shown in FIG. 1, but a plurality of terminals maybe used), and a router 3 are provided in a store 1. The POS terminal 2 and the router 3 are connected by a Local Area Network (LAN) 4 in the store. The router 3 is a device connecting the LAN 4 in the store with a network 5, which is the internet or a Virtual Private Network (VPN). In addition, although not specifically shown, a store server which controls the POS terminal 2 may be provided in the store 1.

Electronic receipt servers 6 are connected to the network 5. A plurality of electronic receipt servers 6 are provided in units of company which operates stores or chain stores (hereinafter referred to as a store), and each of the electronic receipt servers functions as a receipt management server which manages electronic receipt information of the corresponding company that operates a store. In addition, the electronic receipt server 6 may be a headquarter server of a POS system that performs functions such as a sales management, a sales analysis, and an inventory management of the company.

Further, a mobile terminal 8 is connected to the network through a base station 7 which performs wireless communication according to the standard of the Wireless Fidelity (Wi-Fi) or the like. The mobile terminal 8 is an information processing apparatus which has a web browsing function, such as, a smart phone, a mobile phone, a Personal Digital Assistant (PDA), a tablet computer, or the like. In addition, instead of the mobile terminal 8, an information processing apparatus such as a personal computer may be used. Further, an electronic receipt management server 9, which functions as a customer receipt management server that collectively manages the electronic receipt information of various companies, is also connected to the network 5. The customers who have been registered in advance as members may access the electronic receipt management server 9 using the mobile terminal 8 through the network 5 and obtain the electronic receipt information. The electronic receipt management server 9 is managed by for example, a third party other than a company which manages the electronic receipt information stored in the electronic receipt server 6. In addition, the electronic receipt server 6 may be managed by the third party.

In addition, member registration of the customer is executed, for example, in the following manner. The customer transmits a blank email to a member management server (not shown) through the network 5 from the mobile terminal 8. The member management server transmits the Uniform Resource Locator (URL) representing a web page for the member registration to an address from which the email was sent. When the customer accesses the URL representing the web page for the member registration from the mobile terminal 8, an input screen (not shown) is displayed and the customer inputs necessary data for the member registration. After the input of the necessary data by the customer is ended, an input confirmation screen (not shown) is displayed on the mobile terminal 8. Then, after the input information is confirmed by the customer, member registration for a member master is executed. Then, the member management server delivers an email indicating member registration completion, a member code, and a password to the mobile terminal 8. Through the above procedure, the member registration is completed. In addition, after the registration is completed, on a registration completion screen displayed on the mobile terminal 8, the “top screen display” button is displayed. The mobile terminal 8 displays a top screen when the customer selects the “top screen display” button.

In the electronic receipt system described above, electronic receipt information indicating contents of payment, which are generated by the POS terminal 2 performing a product sales data process , is transmitted to the electronic receipt server 6 over the network 5 and to the electronic receipt management server from the electronic receipt server 6. The electronic receipt information is uploaded on the web. Accordingly, the mobile terminal 8 having the web browsing function may download the electronic receipt information uploaded on the web to the mobile terminal 8 by specifying a Uniform Resource Locator (URL), and may browse the information with the web browser. In addition, application software for browsing the electronic receipt information may be installed in the mobile terminal 8 to browse the electronic receipt information.

A configuration of each part constituting the electronic receipt system of the present embodiment will be described.

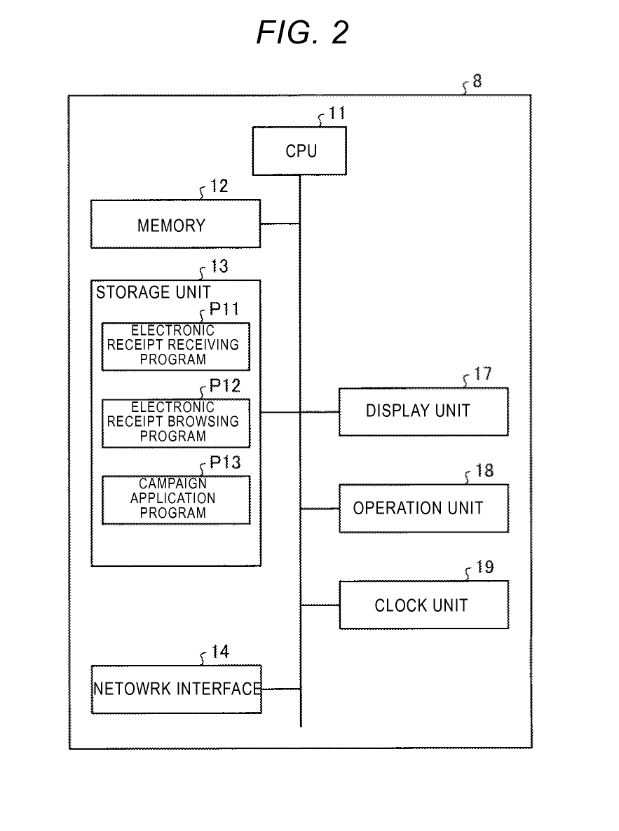

First, main units of the mobile terminal 8, which is an information processing apparatus, will be described with reference to FIG. 2. As shown in FIG. 2, the mobile terminal 8 includes a Central Processing Unit (CPU) 11 constituting a control unit main body, a memory 12 that temporarily stores data, a storage unit 13, from which programs and data can be read and written according to an instruction from the CPU 11, a network interface 14 connected to various public networks including the network 5, a display unit 17 capable of displaying various kinds of information, an operation unit 18 for operating the mobile terminal 8, and a clock unit 19 that measures the time, and the like. The operation unit 18 is a touch panel laminated on the display unit 17 or keys provided on a case of the mobile terminal 8.

In addition to the web browser for browsing various kinds of information (content) published on the web, an electronic receipt receiving program P11 used for receiving from the electronic receipt management server 9, the electronic receipt information generated after the completion of payment through the product sales data process and an electronic receipt browsing program P12 used for browsing the received electronic receipt information are installed in advance in the storage unit 13.

In addition, a campaign application program P13 used for applying for an application-type campaign is installed in advance in the storage unit 13.

In addition, the electronic receipt receiving program P11, the electronic receipt browsing program P12, and the campaign application program P13, which are all executed in the mobile terminal 8, can be provided as files of an installable format or in an executable format recorded in a computer-readable recording medium such as a CD-ROM, a flexible disc (FD), a CD-R, and a Digital Versatile Disc (DVD).

Further, the electronic receipt receiving program P11, the electronic receipt browsing program P12, and the campaign application program P13 may be stored in a computer connected to a network such as the internet and downloaded to the mobile terminal 8 through the network. Further, the electronic receipt corresponding program P11, the electronic receipt browsing program P12, and the campaign application program P13 may be distributed over a network such as the internet.

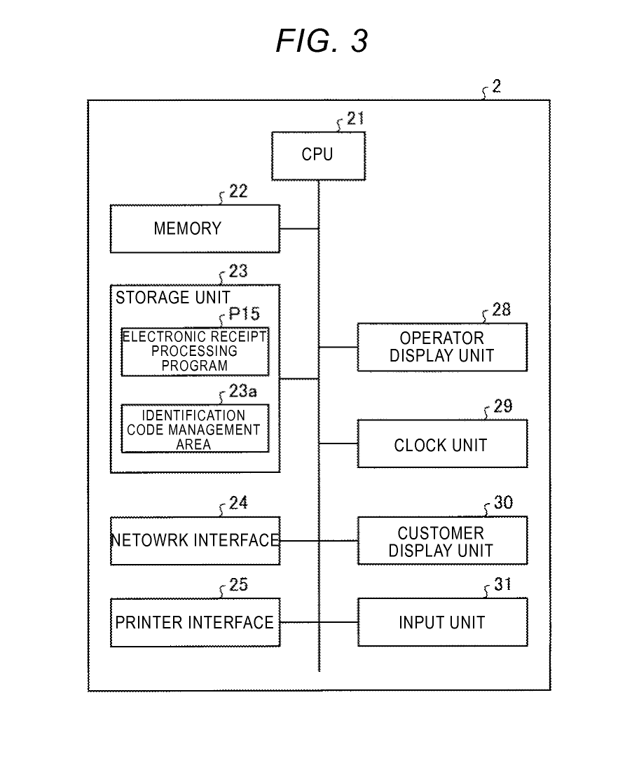

Next, main units of the POS terminal 2, which is the product sales data processing apparatus, will be described with reference to FIG. 3. As shown in FIG. 3, the POS terminal 2 includes a Central Processing Unit (CPU) 21 constituting a control unit main body, a memory 22 that temporarily stores data, a storage unit 23 from and to which programs and data can be read and written according to an instruction from the CPU 21, a network interface 24 connected to a LAN 4 inside a store, a printer interface 25 to which a printer is connected, an operator display unit 28 that displays various kinds of information to an operator, a clock unit 29 that measures the time, a customer display unit 30 that displays various kinds of information to a customer, and an input unit 31 for the operator's operating the POS terminal 2, and the like.

The storage unit 23 has an identification code management area 23a, in which, in addition to the POS number of the POS terminal 2, a company code (identification code of a company that operates a store), a business type code, a store code indicating a store 1 where the POS terminal 2 installed, or the like are stored in advance. Here, the business type code is a code (classification code) indicating business types of stores, for example, convenience stores, supermarkets, department stores, pharmacies, restaurants, places to eat and drink, or the like. In addition, such business type may be determined arbitrarily according to the user's preference. In addition, the company code (identification code of the company that operates the store) and the business type code may be registered in the electronic receipt server 6.

Further, in addition to software for performing various POS processing including the product sales data processing, an electronic receipt processing program P15 for processing electronic receipt information electronically obtained, instead of a printed receipt or a written receipt issued during the product sales data processing is installed in advance in the storage unit 23.

In addition, the electronic receipt processing program P15 executed in the POS terminal 2 is provided as files of an installable format or in an executable format recorded in a computer-readable recording medium such as a CD-ROM, a flexible disc (FD), a CD-R, and a Digital Versatile Disc (DVD).

Further, the electronic receipt processing program P15 executed in the POS terminal 2 may be stored in a computer connected to a network such as the internet and downloaded through a network. Further, the electronic receipt processing program P15 may be distributed over a network such as the internet.

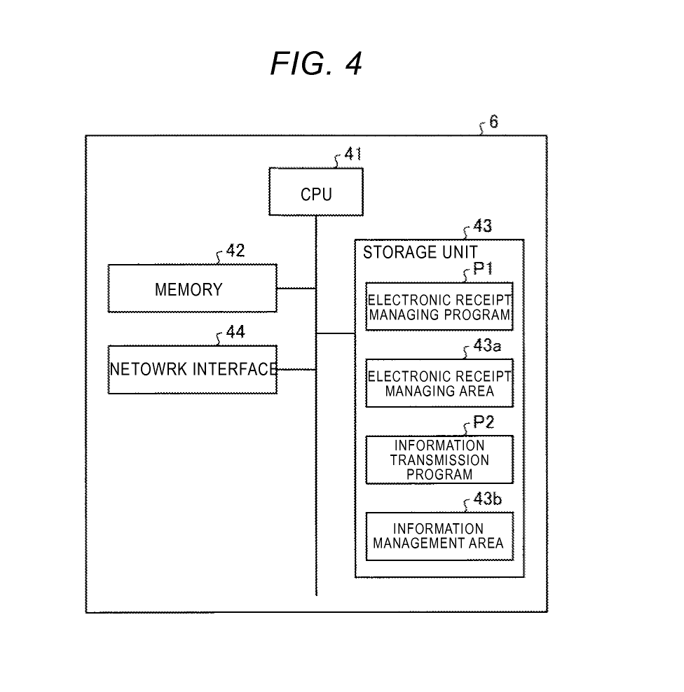

Next, main units of the electronic receipt server 6, which functions as a receipt management server for a company, will be described with reference to FIG. 4. The electronic receipt server 6 is configured from a Central Processing Unit (CPU) 41 constituting a control unit main body, a memory 42 that temporarily stores data, a storage unit 43 from and to which programs and data can be read and written according to an instruction from the CPU 41, and a network interface 44 connected to a network 5, and the like.

The storage unit 43 has an electronic receipt management area 43a as an area for storing electronic receipt information for each company that operates a store. The electronic receipt information includes a company code (identification code of the company that operates the store), the business type code, a store code, a member code of shoppers, a POS number of the POS terminal 2, a receipt number, and product sales data, and the like.

Further, an electronic receipt management program P1 is stored in the storage unit 43 in advance so that the electronic receipt management area 43a can manage the electronic receipt information received from the POS terminal 2 of each store 1.

Further, an information transmission program P2 is also stored in the storage unit 43 in advance so that the electronic receipt information, which is managed in the electronic receipt management area 43a, can be transmitted to the electronic receipt management server 9.

Further, the storage unit 43 has an information management area 43b for storing various kinds of additional information in association with a desired product (product code), a member (member code), a company (company code), and a store (store code). Here, the additional information is campaign information relating to a campaign associated with, for example, a predetermined product information and a specific condition (for example, a specific company that operates a store, a specific region, a specific store, a specific time, or the like), and access information such as a URL linked to a website associated with a campaign of a company, a URL linked to a website associated with a commercial of a company, and a URL linked to a coupon of a company.

In addition, the electronic receipt management program P1 and the information transmission program P2, which are executed in the electronic receipt server 6, may be provided as files of an installable format or in an executable format recorded in a computer-readable recording medium such as a CD-ROM, a flexible disc (FD), a CD-R, and a Digital Versatile Disc (DVD).

Further, the electronic receipt management program P1 and the information transmission program P2 may be stored in a computer connected to a network such as the internet and downloaded through a network. Further, the electronic receipt management program P1 and the information transmission program P2 may be distributed over a network such as the internet.

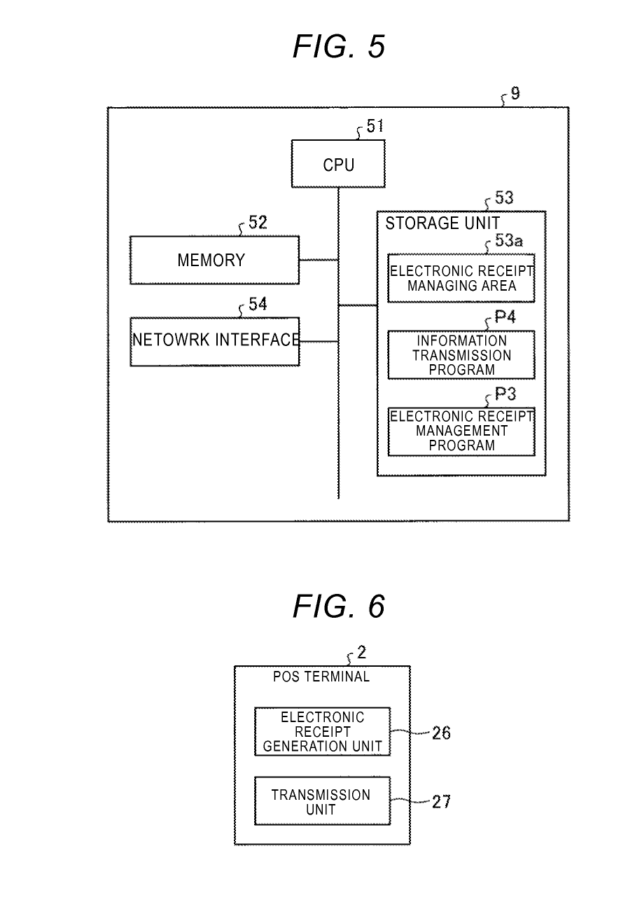

Next, main units of the electronic receipt management server 9, which functions as a customer receipt management server, will be described with reference to FIG. 5. The electronic receipt management server 9 includes a Central Processing Unit (CPU) 51 constituting a control unit main body, a memory 52 that temporarily stores data, a storage unit 53 from and to which programs and data can be read and written according to an instruction from the CPU 51, and a network interface 54 connected to a network 5, and the like.

The storage unit 53 has an electronic receipt management area 53a for collectively storing the electronic receipt information of various companies that operate stores. More specifically, an electronic receipt management area 53a manages electronic receipt information and additional information (campaign information) of various companies that operate stores, with respect to each member.

The electronic receipt information includes a member code, a company code (identification code of a company that operates a store), a store code, a POS number of the POS terminal 2, a receipt number, and product sales data (including a date and a time), and the like. Accordingly, for example, manufacturers of consumer goods may obtain information of the manufacture's product that has been purchased under the specific condition (for example, a limit to a specific company that operates a store, a limit to a specific region, a limit to a specific time, and the like) from the electronic receipt information. In addition, the consumer goods are, for example, groceries, beverages, clothing, cosmetics, chemicals, and household goods.

Further, an electronic receipt management program P3 is stored in the storage unit 53 in advance so that the electronic receipt management area 53a can manage additional information and electronic receipt information received from the electronic receipt server 6 of each company.

Further, an information transmission program P4 is stored in the recording unit 53 in advance so that the electronic receipt information and the additional information of the predetermined product can be transmitted to the mobile terminal 8.

In addition, the electronic receipt management program P3 and the information transmission program P4, which are executed in the electronic receipt management server 9, may be provided as files of an installable format or in an executable format recorded in a computer-readable recording medium such as a CD-ROM, a flexible disc (FD), a CD-R, and a Digital Versatile Disc (DVD).

Further, the electronic receipt management program P3 and the information transmission program P4 may be stored in a computer connected to a network such as the internet and downloaded through a network. Further, the electronic receipt management program P3 and the information transmission program P4 may be distributed over a network such as the internet.

Next, processing performed by each part of a system according to the present embodiment will be described.

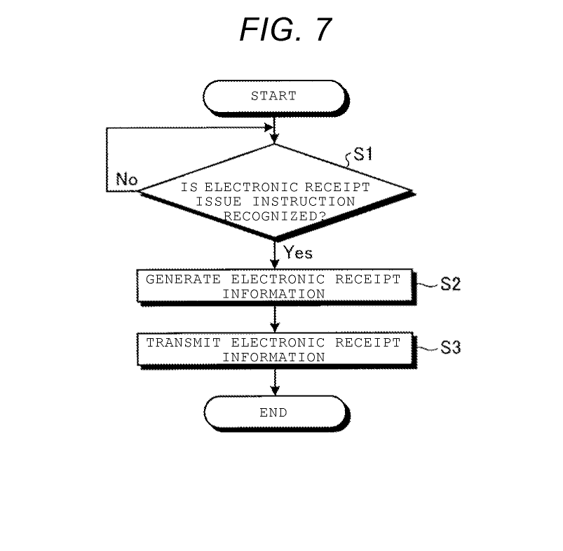

First, an electronic receipt processing performed by the CPU 21 of the POS terminal 2 executing the electronic receipt process program P15 will be described with reference to FIG. 6 and FIG. 7.

As shown in FIG. 6, when the electronic receipt processing program P15 is executed in the POS terminal 2, a module including an electronic receipt generation unit 26 functioning as the electronic receipt generation means and a transmission unit 27 functioning as the transmission means is conceptually created. In actual hardware, when the CPU 21 reads and executes the electronic receipt processing program P15 from the storage unit 23, each unit is loaded on the memory 22, and the electronic receipt generation unit 26 and the transmission unit 27 are created in the memory 22.

The electronic receipt generation unit 26 generates electronic receipt information electronically obtained, instead of a printed receipt or a written receipt issued during the product sales data processing, including a company code indicating a company that operates a store, in association with the member code of the shopper.

The transmission unit 27 transmits the electronic receipt information generated by the electronic receipt generation unit 26 to one of the electronic receipt servers 6 that manages the electronic receipt information for each company according to the company code.

As shown in FIG. 7, when there is an input of an operation key for starting the decision process of product transaction, the CPU 21 (electronic receipt generation unit 26) of the POS terminal 2 determines whether there is an input of the member code, a preset to issue the electronic receipt, and an electronic receipt issuing instruction corresponding to the payment process according to the decision process (step S1).

For example, a method shown below is considered in order for a member to give the electronic receipt issuing instruction.

1. A clerk operates an “electronic receipt issue” button provided in an input unit 31 (for example, a keyboard) of the POS terminal 2 upon request of the member.

2. A customer, who is a member, operates the mobile terminal 8 to display a bar code including a code as a trigger on the display unit 17 of the mobile terminal 8, and the clerk reads out the code with the input unit 31 (for example, bar code scanner) of the POS terminal 2.

3. The customer, who is a member, operates the “electronic receipt issue” button that is displayed on the customer display unit 30.

4. The customer, who is a member, operates the mobile terminal 8 to display the bar code including the code as the trigger on the display unit 17 of the mobile terminal 8, and the customer by himself or herself operates the input unit 31 (for example, bar code scanner (a scanner different from the scanner used in the product registration is preferable)) of the POS terminal 2 to read the code.

When it is determined that there is the electronic receipt issue instruction (Yes of step S1), the CPU 21 (electronic receipt generation unit 26) of the POS terminal 2 transmits product transaction data to a headquarter server, and, separately from the product transaction data, extracts a company code (identification code of the company that operates a store), a business type code, a store code, a member code of a shopper, a POS number of the POS terminal 2, a receipt number, product sales data, and the like from a product sales data management area created in the memory 22, based on the information on products registered and information on payment at the time of payment according to the product sales data process so as to generate the electronic receipt information (step S2).

Next, the CPU 21 (transmission unit 27) of the POS terminal 2 connects to the LAN 4 inside the store and network 5 through the network interface 24, transmits the generated electronic receipt information to the electronic receipt server 6 (step S3), and then completes the process. In addition, when it is determined that there is no electronic receipt issue instruction, the CPU 21 prints and issues a paper receipt, transmits the product transaction data to the headquarter server, and then completes the process.

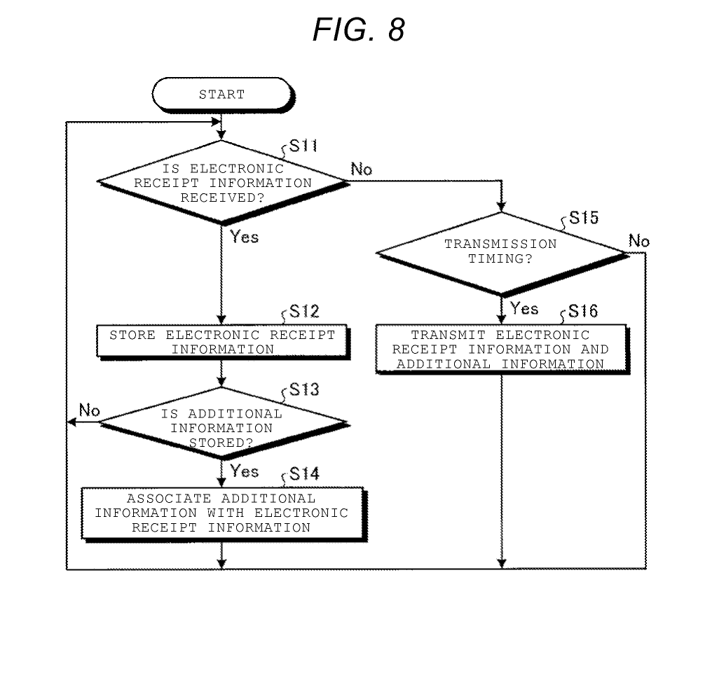

Next, the flow of an electronic receipt management process performed by the CPU 41 of the electronic receipt server 6 operating according to the electronic receipt management program P1 and the flow of an information transmission process performed by the CPU 41 operating according to the information transmission program P2 will be described with reference to a flowchart shown in FIG. 8.

When the CPU 41 of the electronic receipt server 6 receives the electronic receipt information transmitted from the POS terminal 2 through the network interface 44 (Yes of step S11), the CPU 41 causes the received information as the electronic receipt information with respect to each company to be stored in the electronic receipt management area 43a of the storage unit 43 (step S12). That is, the CPU 41 of the electronic receipt server 6 functions as an electronic receipt management unit for storing and managing the electronic receipt information in the storage unit 43 in units of company according to the company code.

Next, the CPU 41 of the electronic receipt server 6 determines whether or not additional information related to the stored electronic receipt information is stored in the information management area 43b (step S13). The additional information is information relating to various campaigns and the like associated with a desired product (product code), a member (member code), a company (company code), a store (store code), and the like.

For example, when it is determined that an additional information “AAAAA” relating to a product code “11111” of the electronic receipt information is stored (Yes of step S13), the electronic receipt information “11111” and the additional information “AAAAA” are associated with each other and stored (step S14).

Further, after the CPU 41 of the electronic receipt server 6 causes the received electronic receipt information to be stored, when it becomes a transmission timing that is set in advance (No of step S11, Yes of step S15), the CPU 41 transmits to the electronic receipt management server 9, the electronic receipt information stored and managed in the electronic receipt management area 43a and the additional information that is stored and managed in the information management area 43b (step S16), and the process returns to step S11.

In addition, although the CPU 21 (electronic receipt generation unit 26) of the POS terminal 2 generates the electronic receipt information and transmits the electronic receipt information to the electronic receipt server 6, the operation of the CPU 21 is not limited thereto. For example, the CPU 21 of the POS terminal 2, based on the information on the registered product and information on payment at the time of payment by the product sales data process, may transmit a store code, a member code of a shopper, a POS number of the POS terminal 2, a receipt number, product sales data, and the like to the electronic receipt server 6. Then, the CPU 41 of the electronic receipt server 6 may add the company code, the business type code, and the like so as to generate electronic receipt information.

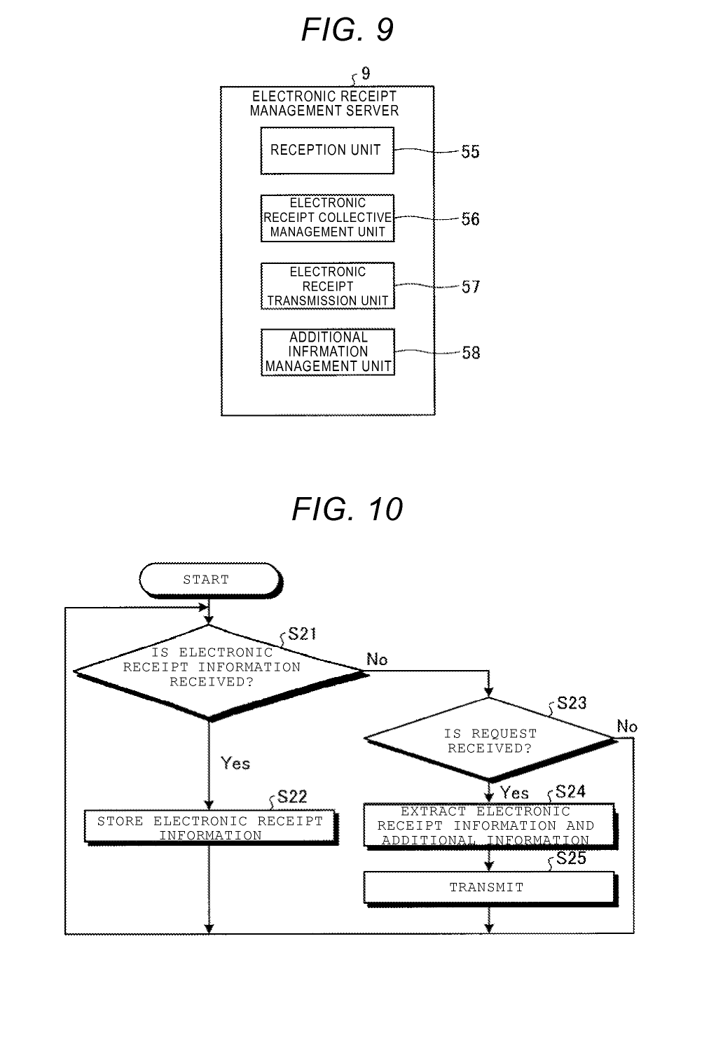

Next, the flow of the electronic receipt management process performed by the CPU 51 of the electronic receipt management server 9 operating according to the electronic receipt management program P3 and the flow of the product information transmission process performed by the CPU 51 of the electronic receipt management server 9 operating according to the information transmission program P4 will be described with reference to FIGS. 9 and FIG. 10.

As shown in FIG. 9, when the electronic receipt management program P3 and the information transmission program P4 are executed in the electronic receipt management server 9, a module including a reception unit 55, an electronic receipt collective management unit 56, an electronic receipt transmission unit 57, and an additional information management unit 58 are conceptually created. In actual hardware, the CPU 51 reads the electronic receipt management program P3 and the information transmission program P4 from the storage unit 53 and executes them. Then, each unit described above on the memory 52, and the reception unit 55, the electronic receipt collective management unit 56, the electronic receipt transmission unit 57, and the additional information management unit 58 are created in the memory 52.

The reception unit 55 receives electronic receipt information in units of company, including a company code indicating the company that operates the store. The electronic receipt information is electronically issued instead of a printed receipt or a written receipt issued during the product sales data process.

The electronic receipt collective management unit 56 causes the electronic receipt information in units of company, which is received by the reception unit 55, to be stored in the electronic receipt management area 53a of the storage unit 53 and collectively manages it. The additional information management unit 58 causes campaign information relating to a campaign associated with a predetermined product and a specific condition (for example, a limit to a specific company that operates a store, a limit to a specific region, a limit to a specific time, and the like) to be stored in the electronic receipt management area 53a of the storage unit 53 and manages it.

The electronic receipt transmission unit 57 acquires electronic receipt information including at least one company code which is associated with the member code, product information included in the electronic receipt information and additional information (campaign information) relating to specific conditions from an electronic receipt management area 53a and transmits the acquired information to a mobile terminal 8 associated with the member code of a predetermined shopper.

As shown in FIG. 10, the CPU 51 (reception unit 55) of the electronic receipt management server 9 determines whether the electronic receipt information and the additional information, which are transmitted from the electronic receipt server 6 of each company, are received through the network interface 54 (step S21).

When the electronic receipt information and the additional information are received (Yes of step S21), the CPU (electronic receipt collective management unit 56 and additional information management unit 58) of the electronic receipt management server 9 causes the electronic receipt information and the additional information of various companies to be collectively stored in the electronic receipt management area 53a of the storage unit 53 (step S22).

Further, when there is a request for an electronic receipt information from the mobile terminal 8 (No of step S21 and Yes of step S23), the CPU 51 (electronic receipt transmission unit 57) of the electronic receipt management server 9 extracts the additional information and the electronic receipt information which are stored and managed in the electronic receipt management area 53a, according to the contents of the request (step S24), then transmits the extracted contents to the mobile terminal 8 that transmits the request (step S25), and returns to step S21.

In addition, the electronic receipt information and the additional information may be transmitted to the mobile terminal 8, not only when there is the request for the electronic receipt information from the mobile terminal 8, but also after the electronic receipt information and the additional information are collectively stored in the electronic receipt management area 53a.

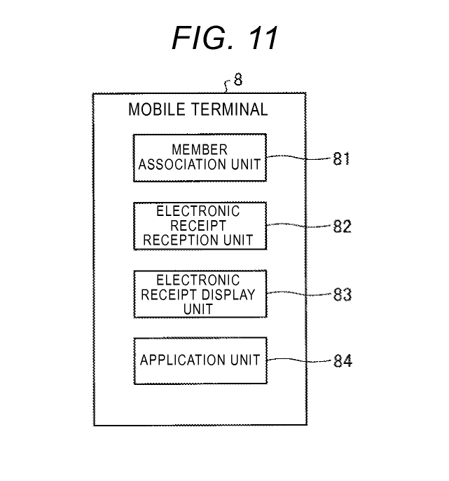

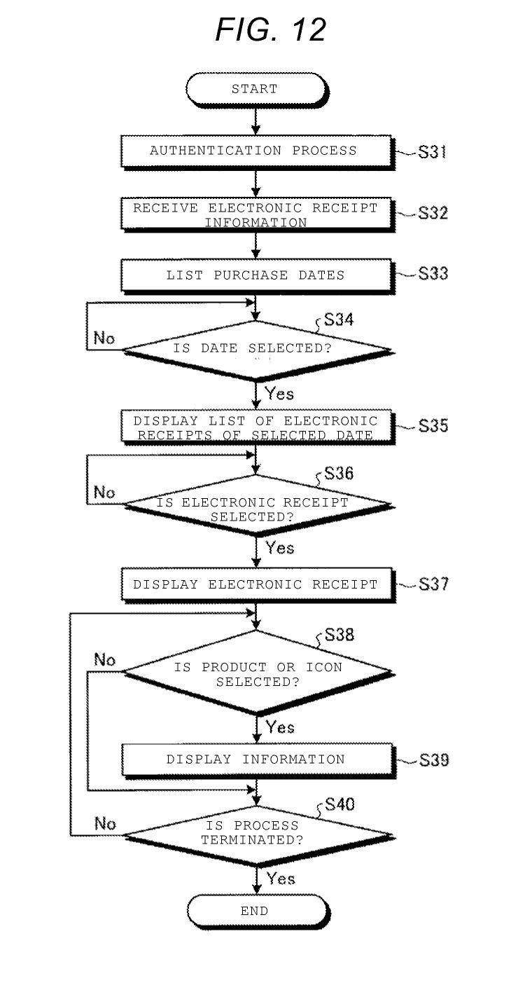

Next, the flow of the electronic receipt receiving process performed by the CPU 11 of the mobile terminal 8 operating according to the electronic receipt receiving program P11 and the flow of the electronic receipt browsing process performed by the CPU 11 of the mobile terminal 8 operating according to the electronic receipt browsing program P12 will be described with reference to FIGS. 11 and 12.

As shown in FIG. 11, when the electronic receipt receiving program P11 and the electronic receipt browsing program P12 are executed in the mobile terminal 8, a module including a member association unit 81, an electronic receipt reception unit 82, an electronic receipt display unit 83, and an application unit 84 are conceptually created. In actual hardware, the CPU 11 reads the electronic receipt receiving program P11 and the electronic receipt browsing program P12 from the storage unit 13 and executed them. Then, the member association unit 81, the electronic receipt reception unit 82, and the electronic receipt display unit 83 are created in the memory 12.

The member association unit 81 associates the electronic receipt information with the member code of a predetermined shopper. The electronic receipt reception unit 82 receives the electronic receipt information including at least one company code associated with the member code, and the additional information (campaign information) relating to the campaign associated with the specific condition and the product information included in the electronic receipt information, from the electronic receipt management server 9 that collectively manages the electronic receipt information.

The electronic receipt display unit 83 arranges the electronic receipt information received by the electronic receipt reception unit 82 in units of company code, causes the display unit 17 to display the electronic receipt information and an icon indicating application to a campaign corresponding to the additional information (campaign information) associated with the specific condition and the product information included in the electronic receipt information. When the displayed icon is selected, the application process can be instructed.

When the icon displayed on the display unit 17 is selected through the operation unit 18, the application unit 84 recognizes the selecting operation as a process to start the campaign application. In other words, when the displayed icon is selected, the process of the campaign application is started.

As shown in FIG. 12, first, the CPU 11 (member association unit 81) of the mobile terminal 8 access the electronic receipt management server 9 and performs an authentication process in response to input of the member code and the password by the user (step S31). Thus, the mobile terminal 8 is associated with the member code of the predetermined shopper.

After the authentication, the CPU 11 (electronic receipt reception unit 82) of the mobile terminal 8 receives the additional information and the electronic receipt information which are stored and managed in the electronic receipt management area 53a of the electronic receipt management server 9 corresponding to the input member code (step S32). The additional information and the electronic receipt information may be received through an email.

Next, the CPU 11 (electronic receipt display unit 83) of the mobile terminal 8 causes the purchase dates that are included in the electronic receipt information to be listed up on the display unit 17 (step S33). As the purchase dates are listed up on the display unit 17, the mobile terminal 8 prompts the user, who is a shopper, to select one of the purchase dates.

As an example of the display format, a calendar format can be used. For example, the dates when the user of the mobile terminal 8 buys goods in stores can be displayed with different color. Further, the CPU 11 (electronic receipt display unit 83) of the mobile terminal 8 causes the dates displayed with the different color to be selectable by the user with the cursor following the input of the operation unit 18.

In addition, a search window in which a search key can be input may be displayed in the display unit 17. The CPU 11 of the mobile terminal 8 may search for the electronic receipt information including the word input in the search window.

Further, the display example may have a “receipt request” button for confirmation after the user selects the date with the cursor. Thus, the CPU 11 of the mobile terminal 8 may determine that the date is selected only by the user tapping the date, or may determine that the date is selected when the user operates the “receipt request” button B1 after the user taps the date.

In addition, the display example has a “campaign” button for moving to an application type campaign page.

In addition, the display example may have marks representing the stores at which the user of the mobile terminal 8 bought goods with respect to each of the purchase dates. The user can intuitively recognize the store where the user bought goods. That is, according to such a display example, the user can easily recognize the store at which the user frequently buys goods. In addition, in order to display the mark representing the store, a table may be prepared in which the mark is associated in advance with the company code that is included in the electronic receipt information.

When it is determined that the user taps and selects the date (Yes of step S34), the CPU 11 (electronic receipt display unit 83) of the mobile terminal 8 controls the display unit 17 to display a list of electronic receipts corresponding to the selected date (step S35).

More specifically, the electronic receipts are listed according to the transaction time in the chronological order, and the company mark, the transaction time, the company name, and the store name are displayed. Further, the CPU 11 (electronic receipt display unit 83) of the mobile terminal 8 enables the user to select one of the electronic receipts on the selected date listed on the display unit 17 with the curser following the input on the operation unit 18.

In addition, it is possible to display a “time bar” in which times are displayed at a predetermined time interval, in addition to the list of electronic receipts. For example, the time interval is one hour. Since the listed electronic receipts are displayed along the time bar according to its transaction time, it is easy to recognize blank time during which no the electronic receipt is issued.

In addition, it is possible to list only the electronic receipts issued by stores of a specific company which are sorted in chronological order by the user touching the company mark. In this way, only electronic receipts issued by stores of a specific company can be listed, and thus how frequently the user purchases goods at the stores may be easily recognized.

When it is determined that the user selects one of the listed electronic receipts (Yes of step S36), the CPU 11 (electronic receipt display unit 83) of the mobile terminal 8 controls the display unit 17 to display the electronic receipt (step S37).

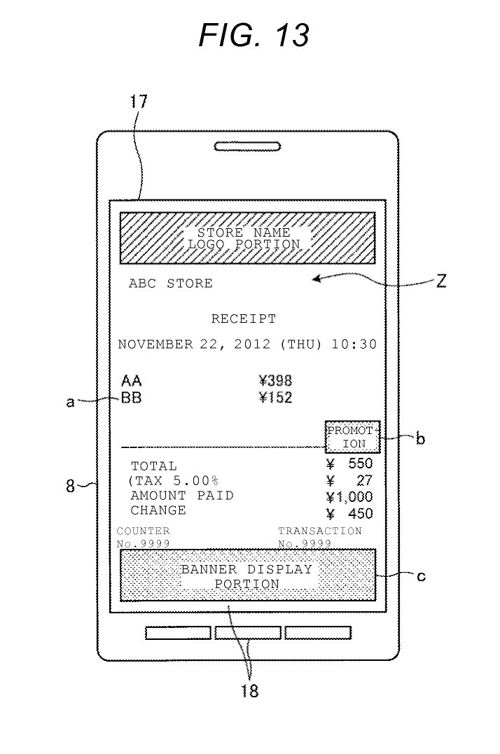

FIG. 13 is a front view of the mobile terminal 8 in which the display unit 17 displays an example of an electronic receipt Z. As shown in FIG. 13, the electronic receipt Z is one issued by a specific store on the selected date, when the user of the mobile terminal 8 bought goods. The electronic receipt Z is displayed in the same layout as the paper receipt by analyzing the electronic receipt information. In the electronic receipt Z, it is possible to focus on, select and operate a product a or an icon b (icon of the button shape of “application” in FIG. 13) indicating the start of the application process for various items of additional information (for example, campaign information) associated with the product, with the cursor following the input of the operation unit 18.

In addition, the electronic receipt does not need to be displayed in the same layout as the paper receipt. However, in the electronic receipt Z, the following information is displayed so that the electronic receipt can be used for return and refund of purchased items.
Store name
Purchase date
Purchase product specification
Total sales amount
Register number
Transaction number

Here, when the user selects a specific product, or an icon associated with the product (Yes of step S38), the CPU 11 (electronic receipt display unit 83) of the mobile terminal 8 is connected to the network 5 through the network interface 14, and obtains through the network 5 various kinds of the information based on the access information associated with the product or icon that is selected and controls the display unit 17 to display the obtained information (step S39).

For example, when a website associated with the product as the access information for a product a is set as product information link, when the product is selected, the website associated with the product is displayed on the display unit 17.

Further, when a website associated with application campaign is set as the access information for an icon b of button shape of “application”, when the icon b of button shape of “application” is selected, the page of the application type campaign associated with the icon b is displayed on the display unit 17.

Conventionally, as a campaign of a company, there is an application type campaign that can be applied to with a campaign seal (purchase certification) attached to a campaign target product. The purchaser applies for the campaign by inputting the seal number described on the campaign seal in the application web page specified by the URL.

In contrast, in the electronic receipt system according to the present embodiment, there is no need to attach the campaign seal (purchase certification) to the campaign target product. Instead, a digital purchase certification can be obtained by digitizing the product sales data included in the electronic receipt information, and the electronic receipt information, which is the digital purchase certification, can be obtained by the manufacturers or the like of the product. This allows only the consumer who bought the campaign target product to apply for the campaign, and thus it is possible to correctly manage the campaign. Further, since the icon b of button shape of “application” is displayed on the display screen of the electronic receipt, it is possible to inform a user who does not know the campaign of the campaign and to effectively conduct the campaign.

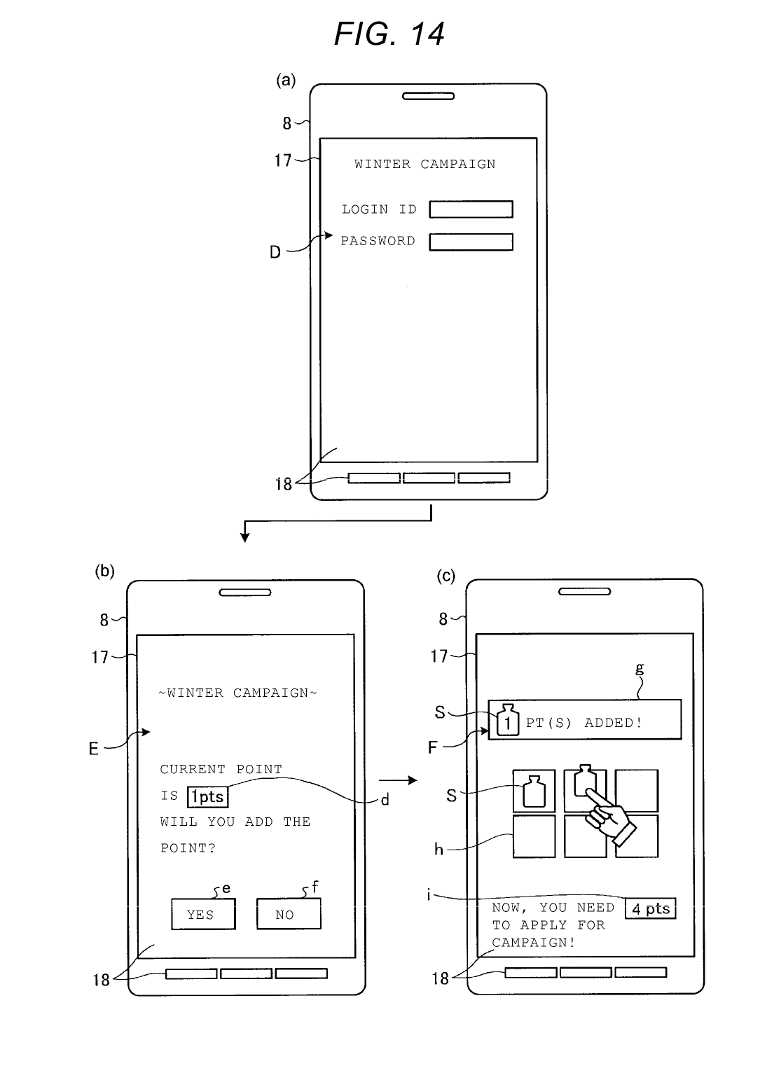

Here, the flow of the campaign application process performed by the CPU 11 of the mobile terminal 8 operating according to the campaign application program P13 that is executed according to the selection of the icon b of button shape of “application” will be described with reference to FIG. 14.

In addition, a limit to the number the user can select the icon b of button shape of “application” (for example, only once) may be set. In this case, it is preferable to refer to the entry master of a promotion management server (not shown) for managing the application history for each type of the campaign in association with the member code.

FIG. 14 shows the flow of the campaign application process. As described above, the electronic receipt Z shown in FIG. 13 is one that displays the electronic receipt information of a specific store on a specific date when the user of the mobile terminal 8 bought goods.

When the icon b of button shape of “application” shown in FIG. 13 is selected, the CPU 11 of the mobile terminal 8 starts the application process of the application type campaign. First, the CPU 11 of the mobile terminal 8 determines whether or not the customer has registered to the application type campaign associated with the icon b.

When it is determined that the customer has not registered to the application type campaign associated with the icon b, with reference to the entry master of a promotion management server, the CPU 11 of the mobile terminal 8 executes an entry process.

The display unit 17 of the mobile terminal 8 displays an entry screen for the entry process of such application type campaign, and the user sets “login ID” and “password”. The setting of “login ID” and “password” is carried out in a procedure similar to the member registration of the customer. The customer transmits a blank email to the promotion management server (not shown) through the network 5 from the mobile terminal 8. The promotion management server transmits the Uniform Resource Locator (URL) representing the page for the entry to the email address from which the blank email was sent. When the customer accesses the URL representing the page for the entry from the mobile terminal 8, the CPU 11 of the mobile terminal 8 controls the display unit 17 to display the entry screen. The customer inputs the data necessary for entry on the entry screen displayed on the display unit 17 of the mobile terminal 8. After the input by the customer is confirmed, the registration for entry master of the promotion management server is executed.

When it is determined that the entry process is executed or the customer completes the entry for the application type campaign associated with the icon b by referring to the entry master of the promotion management server, the CPU 11 of the mobile terminal 8 controls the display unit 17 to display a login screen D shown in (a) of FIG. 14. The customer inputs the “login ID” and “Password” on the login screen D displayed on the display unit 17 of the mobile terminal 8.

After login is authenticated, the CPU 11 (application unit 84) of the mobile terminal 8 performs the application process with the promotion management server. For example, the application process is a process for adding one point when the icon b of button shape of “application” is selected once. In this case, the CPU 11 of the mobile terminal 8 controls the display unit 17 to display a campaign application screen E as shown in (b) of FIG. 14. In (b) of FIG. 14, a point number display portion d refers to the number of points accumulated in the promotion management server, “Yes” button e is used for adding points and “No” button f is used for cancelling the addition of points and ending the process.

When the “Yes” button e is selected, the CPU 11 of the mobile terminal 8 controls the display unit 17 to display a point addition screen F as shown in (c) of FIG. 14. An newly acquired point display area g, an accumulated point display area h, and a required point display portion i are displayed on the point attached screen F shown in (c) of FIG. 14.

As shown in (c) of FIG. 14, the acquired point display area g is an area for displaying the number of points acquired at this time. Further, the acquired point display area g displays also a symbol S representing the number of points acquired at this time. For example, assuming that one symbol S corresponds to one point, when one point is acquired, one symbol S is displayed on the acquired point display area g.

Further, as shown in (c) of FIG. 14, the accumulated point display area h is an area for displaying the total number of points accumulated in the promotion management server. More specifically, the accumulated point display area h has a plurality of areas arranged in a matrix shape. Then, symbols S representing the total number of points are displayed on a predetermined box of the accumulated point display area h. That is, the symbol S is shaped to fit in each box of the accumulated point display area h.

Then, as shown in (c) of FIG. 14, the customer may drag and drop the symbol S displayed in the acquired point display area g to a predetermined area of the accumulated point display area h using the operation unit 18 (touch panel laminated on the display unit 17). Thus, the user may increase the number of points accumulated in the promotion management server.

By doing so, the customer (consumer) may virtually accumulate the points on the display unit 17 in a similar manner as physically attaching a seal, which is usually attached on the target product, to a card board.

Further, as shown in (c) of FIG. 14, the required point display portion i displays the number of points needed for the campaign application. As described above, the number of points displayed on the required point display portion i is updated according to the drag-and-drop operation of the symbol S into the accumulated point display area h by the customer.

When the number of points displayed on the required point display portion i reaches zero, the CPU 11 of the mobile terminal 8 (application unit 84) controls the display unit 17 to display an application button (not shown) on a point attached screen F, instead of the remaining point display portion i.

When the application button is selected, the CPU 11 of the mobile terminal 8 transmits a notification that the accumulated number of points will be used for applying a campaign to the promotion management server, and returns to the electronic receipt Z. In addition, in the electronic receipt Z after the application, the icon b of button shape of “application” shown in FIG. 14 is not displayed.

Further, when a website associated with a commercial is set as access information for a banner c which is a kind of icon, when the banner c is selected, the commercial associated with the banner c is displayed on the display unit 17.

When termination of the electronic receipt browsing process is selected with the operation unit 18 (Yes of step S40), the CPU 11 of the mobile terminal 8 terminates the process.

When termination of the electronic receipt browsing process is not selected with the operation unit 18 (No of step S40), the CPU 11 of the mobile terminal 8 returns to step S38 and stays on standby for a selection of a product or an icon associated with the product.

As described above, according to the electronic receipt system of the present embodiment, a consumer goods manufacturer or the like can conduct the sales promotion campaign, which conventionally has been targeted for unspecified customers, under a specific condition using the electronic receipt information. The specific condition includes, for example, a limit to a specific company that operates a store, a limit to a specific region, a limit to a specific time, and the like.

Further, according to the electronic receipt system of the present embodiment, since the consumer goods manufacturer or the like can obtain electronically unique certificate information of a purchased product associated with the manufacturer, it is possible to greatly reduce costs for the campaign.

Further, according to the electronic receipt system of the present embodiment, the customer (consumer) can virtually accumulate points in a similar manner as physically attaching a seal, which is usually attached on the target product, to the card board. Thus, it is possible to provide a campaign application scheme similar to the conventional scheme in which the consumer can recognize the point collection status at a glance.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A server comprising:
a storing unit configured to store electronic receipt information including an item purchased by a customer, customer information, and promotion information for a predetermined item;
a communication unit configured to receive a request for the electronic receipt information from a communication device, and transmit the electronic receipt information to the communication device; and
a controller configured to associate the electronic receipt information with the promotion information if the purchased item is the predetermined item, and control the communication unit to transmit the electronic receipt information with the associated promotion information to the communication device in response to the request for the electronic receipt information.

2. The server according to claim 1, wherein
the communication unit is further configured to receive user information identifying a user of the communication device, and
the controller is further configured to determine whether the received user information corresponds to the stored customer information and control the communication unit to transmit the electronic receipt information and the promotion information to the communication device when the user information corresponds to the customer information.

3. The server according to claim 1, wherein
the controller is configured to control the communication unit to transmit the electronic receipt information and the promotion information along with a message about the promotion to be displayed on a display unit of the communication device with the electronic receipt information and the promotion information.

4. The server according to claim 3, wherein
the message is an image that is hyperlinked to a web page associated with the promotion.

5. The server according to claim 1, wherein
the storing unit is further configured to store a total score of the customer in the promotion, and
the controller is further configured to control the communication unit to transmit the total score of the customer to the communication device.

6. The server according to claim 5, wherein
the controller is further configured to calculate a value earned through the purchase of the item, and control the communication unit to transmit the earned value with the total score.

7. The server according to claim 6, wherein
the communication unit is further configured to receive a request to increase the total score of the customer from the communication device based on the earned value,
the controller is further configured to control the storing unit to update the total score of the customer by increasing the total score, in response to the request to increase the total score of the customer.

8. A system for managing information, comprising:
a terminal device located in a store and configured to generate electronic receipt information including an item purchased by the customer and customer information, and transmit the generated electronic receipt information and the customer information; and
a server configured to receive the electronic receipt information and the customer information transmitted from the terminal unit, store the received electronic receipt information and the customer information, associate the received electronic receipt information with promotion information for a predetermined item if the purchased item is the predetermined item, and transmit the electronic receipt information and the promotion information associated therewith to a communication device.

9. The system according to claim 8, wherein
the server is further configured to receive user information identifying a user of the communication device, determine whether the received user information corresponds to a stored customer information, and transmit the electronic receipt information and the promotion information to the communication device if the received user information corresponds to the stored customer information.

10. The system according to claim 8, wherein the promotion information includes a hyperlink to a web page associated with the promotion.

11. The system according to claim 8, wherein
the server is further configured to store a total score of the customer in the promotion, and transmit the total score to the communication device.

12. The system according to claim 11, wherein
the server is further configured to calculate a value earned through the purchase of the item, and control the communication unit to transmit the earned value with the total score.

13. The system according to claim 12, wherein
the server is further configured to receive a request to increase the total score based on the earned value from the communication device, and to update the total score by increase the total score, in response to the request to increase the total score.

14. The system according to claim 13, wherein
the server is further configured to transmit, to the communication device, information indicating that the customer is eligible for a reward of the promotion, when the total score of the customer is equal to or greater than a predetermined value.

15. A method for operating a communication device, comprising:
transmitting a request for electronic receipt information including an item purchased by a customer, to a server,
receiving the electronic receipt information and promotion information for a predetermined item; and
displaying the electronic receipt information, the promotion information, and a message about the promotion.

16. The method according to claim 15, wherein
the promotion information includes a hyperlink to a web page associated with the promotion.

17. The method according to claim 15, further comprising:
displaying a total score of the customer in the promotion.

18. The method according to claim 15, further comprising:
displaying a value earned through the purchase of the item.

19. The method according to claim 18, further comprising:
transmitting a request to increase the total score based on the earned value.

20. The method according to claim 19, further comprising:
displaying information indicating that the customer is eligible for a reward of the promotion, when the total score of the customer is equal to or greater than a predetermined value.
